(19) United States
(12) Patent Application Publication
(10) Pub. No.: US 2014/0226584 A1
(43) Pub. Date: Aug. 14, 2014

(54) ADAPTIVE COMMUNICATIONS NETWORK

(71) Applicants: Elizabeth Jane Cullen, Chelmsford-Essex (GB); Richard Norman Herring, Chelmsford-Essex (GB); David John Robert Robson, Chelmsford-Essex (GB)

(72) Inventors: Elizabeth Jane Cullen, Chelmsford-Essex (GB); Richard Norman Herring, Chelmsford-Essex (GB); David John Robert Robson, Chelmsford-Essex (GB)

(73) Assignee: BAE SYSTEMS PLC, London (GB)

(21) Appl. No.: 14/238,751

(22) PCT Filed: Aug. 16, 2012
(86) PCT No.: PCT/GB2012/052001

§ 371 Date: Feb. 13, 2014

(30) Foreign Application Priority Data
Aug. 19, 2011 (GB) 1114329.4

(51) Int. Cl. H04W 40/20

(52) U.S. Cl. CPC H04W 40/20
USPC 370/329

(57) ABSTRACT

Disclosed herein is an adaptive communications network and a method of adapting the network. The network comprises, at least a first and second base station operable to communicate with one another and with a plurality of mobile client platforms (MCPs), at least a first and second MCP, each provided with a communications module, a processing module, and a means of manoeuvring. The first MCP is provided with and operable to execute: a first initial route plan and a first initial communications plan for maintaining a communication link with either of the base stations. Further, the first MCP is operable to collect and transmit first situational awareness data. Similarly, the second MCP is provided with and operable to execute: a second initial route plan and a second initial communications plan for maintaining a communication link with at least one of the base stations, and is operable to collect and transmit second situational awareness data. The method comprises the steps of: i) Establishing a first initial communications plan, the plan identifying an MCP- to-base communications link between the first MCP and the first base station, the first communications link having a first channel frequency ii) Generating first situational awareness data at the first MCP iii) Receiving second situational awareness data at the first MCP iv) Calculating for the first MCP a first updated communications plan.

The present invention relates to an adaptive communications network and a method for adapting such, and particularly but not exclusively, to an adaptive communications network for a plurality of autonomous vehicles.

It is known to provide a communications network where a number of mobile client platforms can communicate with a base station. A base station may alternatively be referred to as a ground control station.

The mobile client platforms establish a communication link with the base station upon moving within range of the base station signal. Typically, in order that the single base station can establish links with a plurality of mobile client platforms without interference, each communication link is assigned a distinct frequency or channel. Often the capacity of the base station (i.e. how many mobile client platforms it can serve) is limited by the number of distinct frequencies at which communication links can be established.

In general, a base station will therefore manage a finite frequency spectrum by assigning a communication link to mobile client platforms on a ‘first come first serve’ basis.

According to a first aspect of the invention there is provided a method of adapting a communications network comprising, providing at least a first and second base station operable to communicate with one another and with a plurality of mobile client platforms (MCPs), providing at least a first and second MCP, each provided with a communications module, a processing module, and a means of manoeuvring; the first MCP being provided with and operable to execute: a first initial route plan and a first initial communications plan for maintaining a communication link with either of the base stations, and being operable to collect and transmit first situational awareness data and the second MCP being provided with and operable to execute: a second initial route plan and a second initial communications plan for maintaining a communication link with at least one of the base stations, and being operable to collect and transmit second situational awareness data the method further comprising the steps of:
i) Establishing a first initial communications plan, the plan identifying an MCP-to-base communications link between the first MCP and the first base station, the first communications link having a first channel frequency
ii) Generating first situational awareness data at the first MCP
iii) Receiving second situational awareness data at the first MCP
iv) Calculating for the first MCP a first updated communications plan.

As such, there is provided a method whereby situational awareness data may be shared between MCPs. With access to such data, the method enables each MCP to adapt its communications plan to provide an optimised/acceptable allocation of base station spectrum, for many given circumstances.

This method allows a de-centralised approach to spectrum management, where communications plans are determined at each MCP, for example in the processing module, according to inputs from various other MCPs. A de-centralised approach, such as may be permitted by the present invention, can allow a wider amount of information to be gathered but also provides a degree of redundancy in the system. In a centralised approach, destruction of the station processing each and every channel request for each and every link would be likely to disable the entire network.

The calculation of the first updated communications plan may take place within the processors on board the first MCP itself. As such, the method can provide an intelligent agent approach to communications brokering. This approach tends to promote a reactive (i.e. able to respond to changes by interacting with the environment), proactive (i.e. able to exhibit goal-oriented behaviour) and social (i.e. able to communicate with other agents in the system) communications network.

The updated communication plan may be calculated according to a metaheuristic algorithm.

The use of a metaheuristic algorithm can lead to viable solutions, eg feasible allocations of channel frequencies for all requested links, within limited timescales.

In particular the metaheuristic algorithm may be a Random Neural Network (RNN) algorithm

RNN algorithms are generally able to be configured to offer a solution within a relatively short timeframe. In the context of real-time telecommunications systems for autonomous vehicles, this can mitigate against errors.

As such, the RNN algorithm, given a set of link-to communication requests from a plurality of platforms, and a set of channels, allocates to each MCP a platform with which to form a link and a channel on which to communicate, by seeking to maximise the following cost function across the network

$$A ( r , c ) = \frac{Q + K ( r ) / \vert C \vert}{[ N ( r , c ) ⊕ {{\sum }_{rcR , {r}^{′} \neq r}}^{⊕} A ( {r}^{′} , c ) I ( r , {r}^{′} c ) ] - S ( r , c )}$$

Where R is the set of requests r, with priority K(r) and C is the set of channels c; A(r, c) is the allocation function, set to 1 if request r is allocated channel c, 0 otherwise; S(r, c) is the received signal power at each terminal of request r on channel c; N(r, c) is the total receiver noise, external noise and jammer power experienced by request r on channel c, and I(r, r′, c) is the interference power which would be received by request r using channel c as a result of request r′ also operating on that channel; all powers are expressed in dBm. These powers are functions of r as well as c because they may depend on the geographical location of the terminals represented by r; the priority K(r) is in dB and represents the relative importance in the request in terms of its signal/interference ratio.

This algorithm has been found to provide results within an acceptable timeframe. The algorithm may not need to determine the absolute minimum of the cost expression as this may consume too much time or computing resource. Hence the method may define an acceptable minimum value of the cost expression which, once reached, may be used to determine the request and channel allocations. Upon reaching the acceptable minimum value, the iterations may cease. Alternatively, or in addition, the algorithm may be configured to terminate after a predetermined number of iterations.

Further, this algorithm has been found to adequately account for, and reduce, problems which may arise as a result of cross interference between MCP signals.

The method may further comprise the steps of:
v) Establishing a second initial communications plan, the plan identifying an MCP-to-base communications link between a second MCP and a second base station at a second channel frequency
vi) Generating second situational awareness data at the second MCP
vii) Receiving first situational awareness data at the second MCP
   viii) calculating for the second MCP a first updated communications plan

Steps v)-viii) may run in parallel with steps i)-iv). As such the method may be executed by either or both of the first and second MCPs. Further, where more than two MCPs are provided, any of these MCPs may execute the method independently.

Such a provision tends to promote a network which readily updates itself and provides each MCP with a degree of autonomy so that information may spread from one point of the network to other points.

Indeed, such a provision can tend to provide a multi-agent system where each MCP in the network shares its particular situational awareness with other MCPs so that each MCP has a convergent shared situational awareness and is able to calculate a common set of communications plans/updates.

Typically the first or second MCP generates situational awareness data may comprise: a route plan, a communications requirements forecast, and a radio quality report.

As such, the network can tend to distribute an amount of information that firstly is adequate to describe the MCPs current environment and its projected behaviour and secondly permits analysis by other MCPs.

For example a first MCP may combine a radio quality report from a second MCP in a certain location with its own native radio quality report, and through processing the reports, infer the existence and approximate location of an area of interference. Having made such an inference, the first MCP may update its communications plan so that upon arrival in the approximate area of interference, it tends to be allocated a frequency channel not known to be prone to the interference.

Further, such a provision helps enable the network to respond in the instance where a particular MCP changes its route plan mid-mission. (Such a change may be instigated by a Command and Control (C2) instruction fed to the MCP from a GCS/Base Station, or as a result of the MCPs own autonomous behaviour.) Upon altering its route plan, the MCP can distribute this as an update to the shared situational awareness data and hence allow the MCPs to replan their communications.

The situational awareness data may also comprise a situation status message which may be distributed about the network to indicate how up-to-date a particular MCPs situational awareness. Such a provision would tend to reduce the burden on the network because full situation status updates may only need to be distributed upon recognising a specific MCP in need of a specific update.

The first updated communications plan may define an updated channel frequency for the MCP-to-base link and each communications plan may include a channel allocation between the respective MCP and at least one of the base stations.

A particular MCP may transmit its respective situational awareness data, as an update, upon detection by the particular MCP of a predefined stimulus.

Such a predefined stimulus may be an unexpected reduction in radio signal quality (from which it may be inferred that a source of interference is present). Accordingly a threshold may be set to determine the minimum quality parameter (e.g. SNR reduction rate) that triggers a transmission of situational awareness data.

As a further example, situational awareness data may be transmitted upon identification of a change to detected noise or jamming level which exceeds a predetermined threshold.

Still further, a situational awareness update may be transmitted by an MCP upon changing its route plan.

Optionally, steps iv and/or v are initiated after a predetermined time period has elapsed since the previous execution of steps iv and/or v

By thus providing that an MCP may also be configured to transmit situational awareness data periodically, even in the absence of a specific stimulus, the method provides for scheduled updates to each MCPs overall situational awareness. This may tend to reduce the computational resource required when a change to the environment does occur.

According to a second aspect of the invention there is provided an adaptive communications network system, the network comprising:—at least a first and second base station operable to communicate with one another and with a plurality of mobile client platforms (MCPs), at least a first and second MCP, each provided with a communications module, a processing module, and a means of manoeuvring; the first MCP being provided with and operable to execute: a first initial route plan and a first initial communications plan for maintaining a communication link with either of the base stations, and being operable to collect and transmit first situational awareness data, and the second MCP being provided with and operable to execute: a second initial route plan and a second initial communications plan for maintaining a communication link with at least one of the base stations, and being operable to collect and transmit second situational awareness data, wherein the communications modules of the first and second MCP are configured to communicate situational awareness data with each other using their communications modules, to process the output from the communications module at the processing module to determine an updated route plan and updated communications plan, to implement the updated route plan at the means for manoeuvring, and to implement the updated communications plan at the communications module.

As such, there is provided a network arrangement which may share data relating to communications between various nodes (i.e. the MCP). With access to such data, the network is able to optimise its communications plan to provide an optimised/acceptable allocation of base station spectrum, in response to given circumstances.

This arrangement is also readily compatible with a de-centralised approach to spectrum management, where communications plans are determined at each MCP, for example in the processing module, according to inputs from various other MCPs.

With the base stations interconnected, it becomes possible to relay a message from the first MCP to a further MCP via the base station network (provided that each MCP is within range of a base station).

The situational awareness data may comprise a route plan/mission plan, a communications requirements forecast, and a radio quality report.

The means of manoeuvring may alternatively be referred to as a Navigation Module.

The communications module may comprise an ATC communications module.

The provision of an ATC communications module, which may be a VHF radio system, enables the MCP to communicate with an air traffic control system (ATC) and can thus generate further and or more accurate situational awareness data.

Typically, an ATC communications module for use in communications with an ATC will operate at a VHF frequency (often defined as the radio frequency range from 30 MHz to 300 MHz). Typically ATCs operate on a fixed frequency.

Each communications module may comprise a means for communicating directly with other MCPs.

In some embodiments, the MCPs may be able to communicate directly with one another. This may tend to reduce latency in the network and improve the speed of decision making in response to events.

Further, with a tendency to provide direct communications between platforms, the system can reduce the potential for capacity bottlenecks e.g. at relay points.

As such each communications module may comprise an IP network module such that each MCP is operable to form an IP network with other local MCPs and thereby share situational awareness data.

Communication protocols which may be used as MCP-MCP communication links would include an Internet Protocol (IP) network established between the platforms. A Wide Area Network (WAN) may be configured between the MCPs for this purpose.

Each MCP communications module may comprise a Base Station communications module for establishing and maintaining a MCP-to-base link.

The particular Base Station communications module provided may vary depending on the Base Station type with which the MCP is intended to communicate.

The provision of a MCP-to-base link enables the communication of for example Command and Control (C2) instructions to the MCPs, which is particularly relevant where MCPs are unmanned or autonomous. However other information may be communicated by means of this link, in particular situational awareness data may be relayed to the Base station for onward communication to another MCP.

Further, if the MCP is provided with not only the sensors in the communications module, but also additional sensors (such as health monitoring sensors, video recorders etc), data from such additional sensors can be communicated to the base station by this link.

In general, the Base Station communications module will be operable at a number of different frequencies so as to provide a plurality of channels over which a communications link between the MCP and the Base station may be established.

Often, a Base Station communications module and a means for communicating directly between MCPs will be functionally equivalent and hence can be implemented within the same hardware (transceiver, antenna etc). Further in such circumstances, only one of these modules need be provided because it may perform both communications roles.

The Base Station communications module may be operable over a 400-900 MHz UHF frequency range such that a MCP-to-base link may be provided within a 400-900 MHz UHF channel.

It follows from the previous discussion of the similarity between the Base Station communications module and a means for directly between MCPs, that the means for direct communication between MCPs could also have these characteristics.

The MCP communications module may comprise a Satellite Communication module.

A satellite communication module may be used to determine further data relating to the situation of the MCP, convey C2 information or may be used to convey situational awareness data between MCPs.

The first and second base stations may be electrically interconnected by means of a hardwired connection.

In general, such an arrangement can tend to maximise the spectrum offered by the base stations to the MCPs for communications because the physical electrical connections between the base stations will not occupy bandwidth in this spectrum.

Alternatively, the base stations may be fitted with addition antenna and communication means which are provided exclusively for transmitting data between the various base stations.

In order that the present invention may be clearly understood, at least one exemplary embodiment thereof shall now be described below and with reference to the figures, of which:

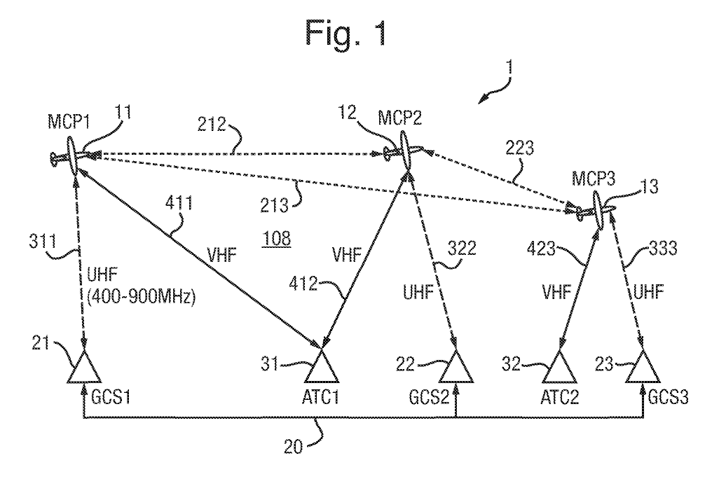

FIG. 1 shows a schematic diagram of an adaptive communications network representing the components and links which are present;

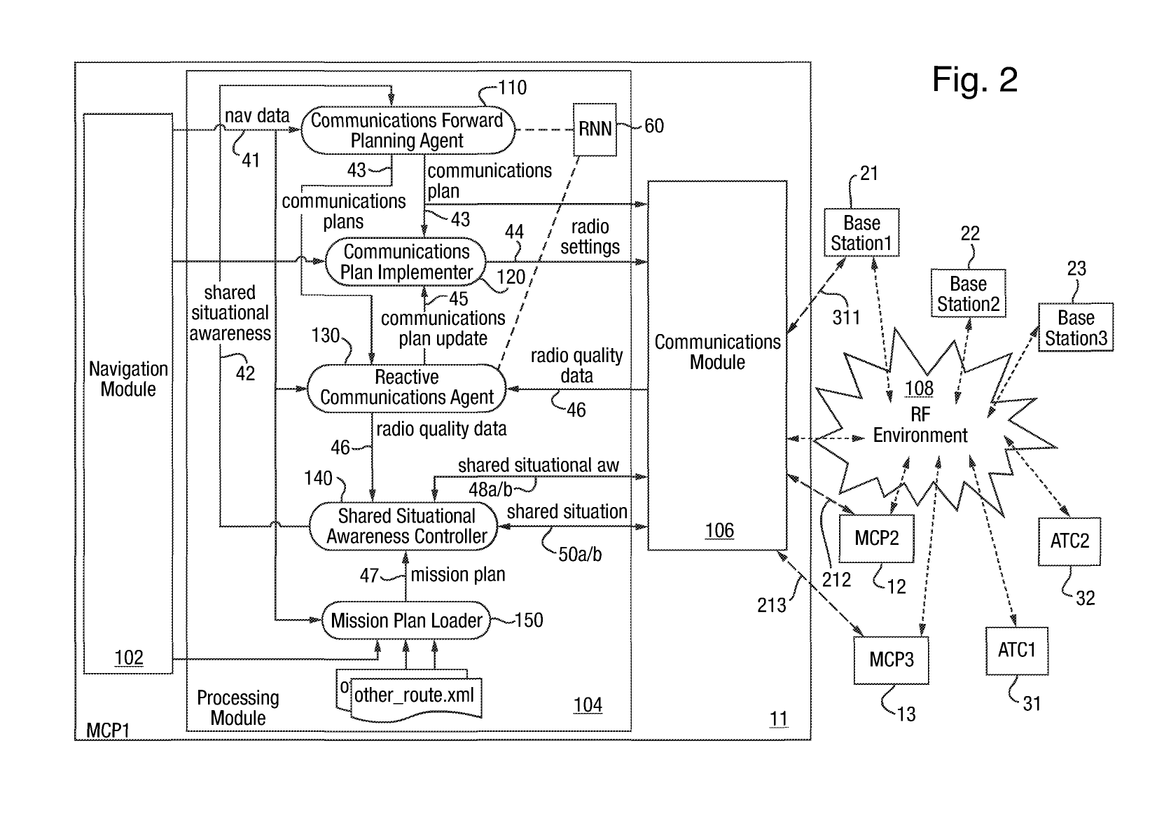

FIG. 2 shows a schematic diagram illustrating the interaction between an MCP and the radio signal (RF) environment, and further detailing the sub-modules in a processing module;

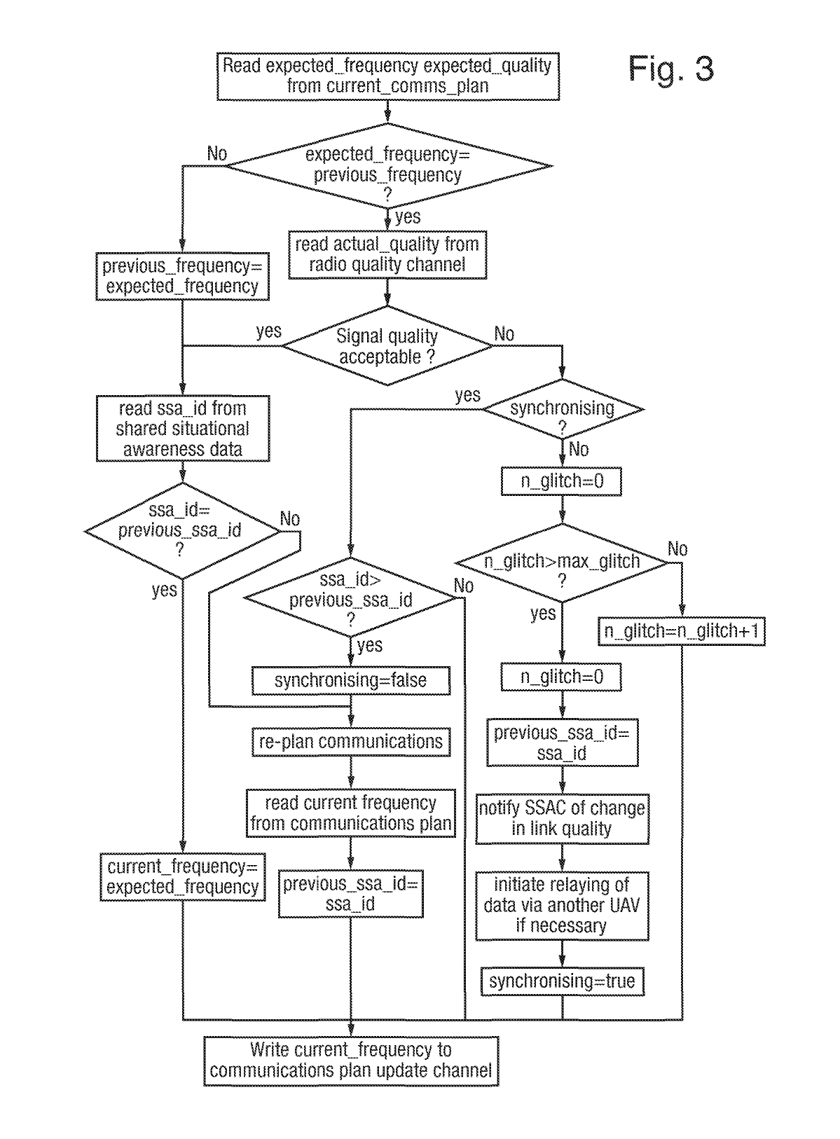

FIG. 3 shows a flow diagram representing a process executed within the processing module to handle instances of lost communications;

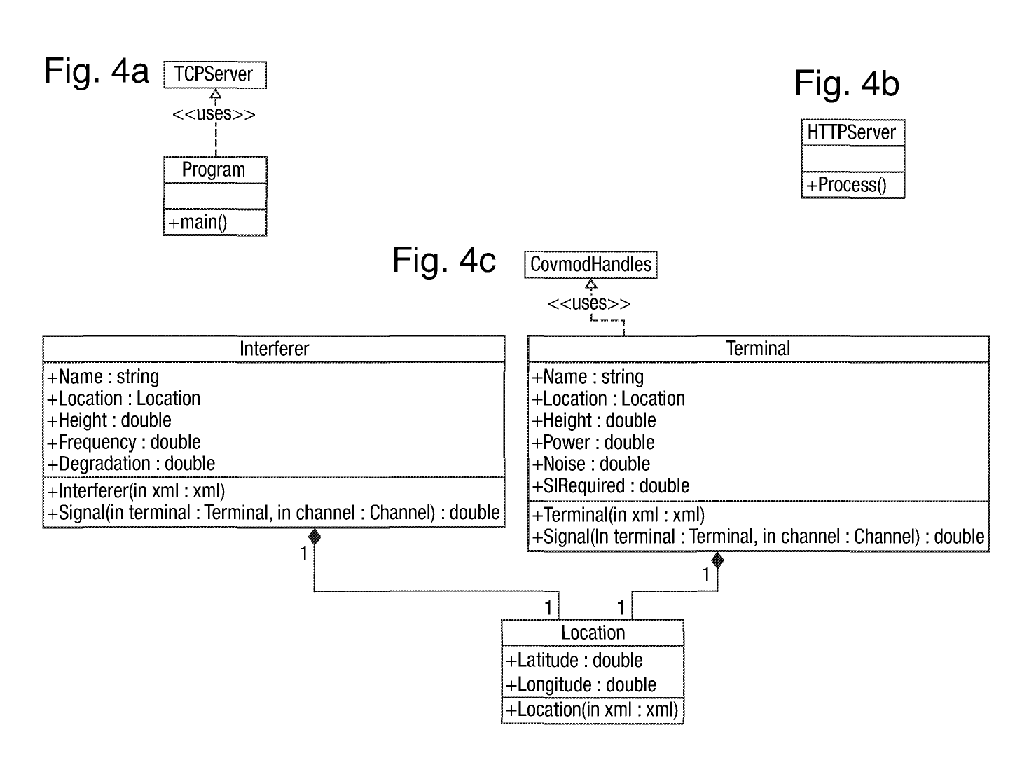

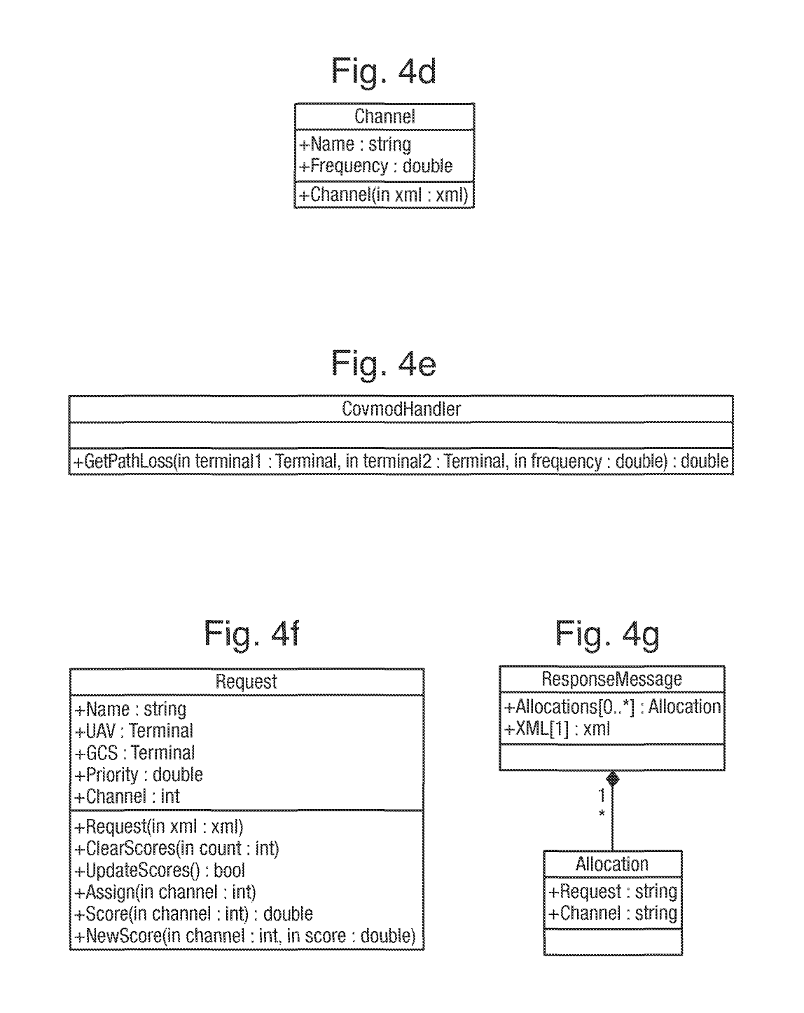

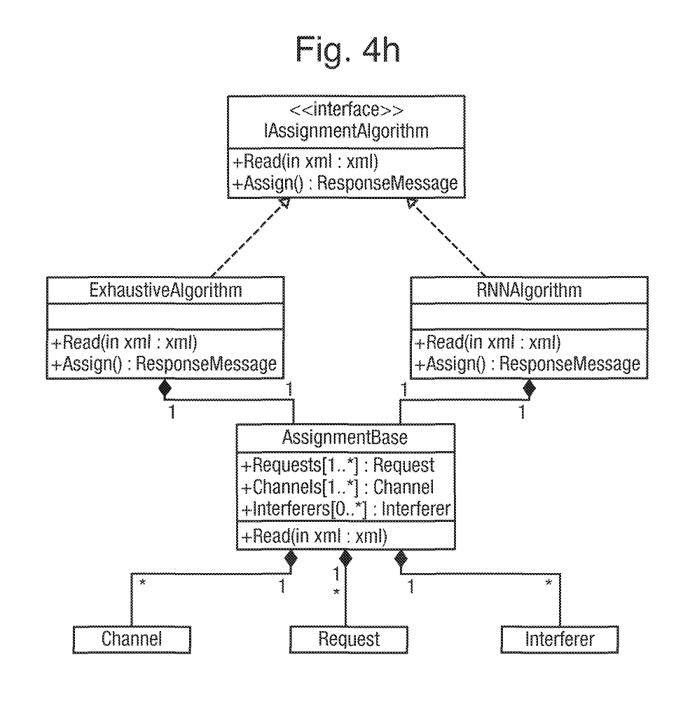

FIGS. 4a-h represent a Unified Modeling Language (UML) class diagram relating to the relationships between classes in a software implementation of an optimisation algorithm used by the network;

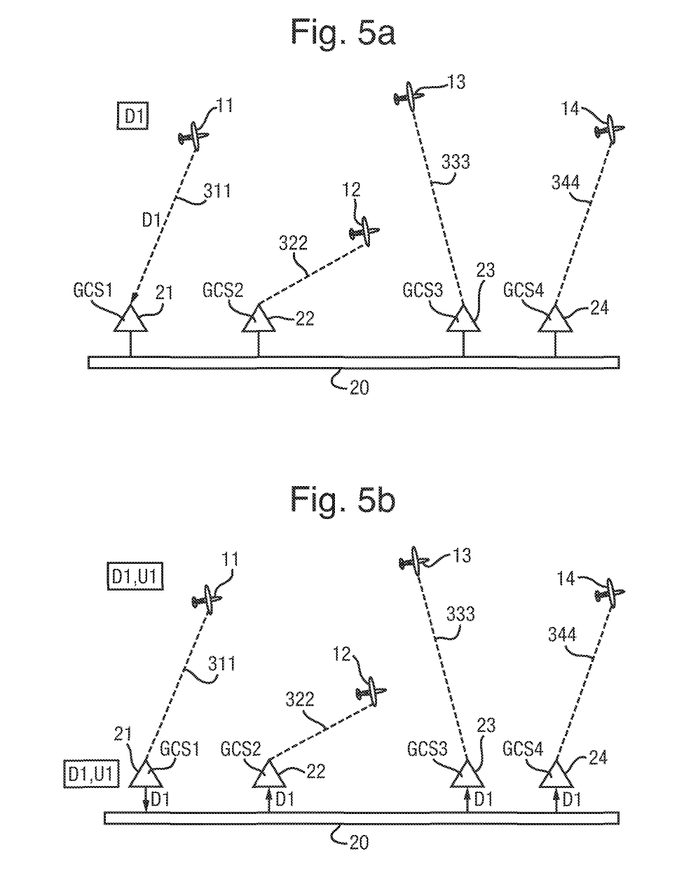

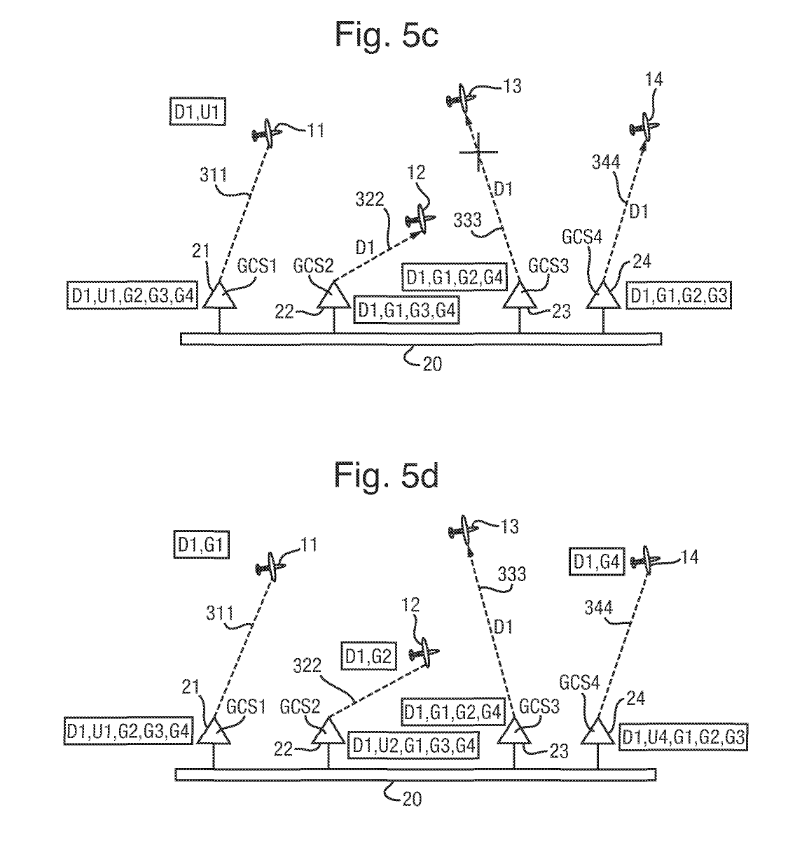

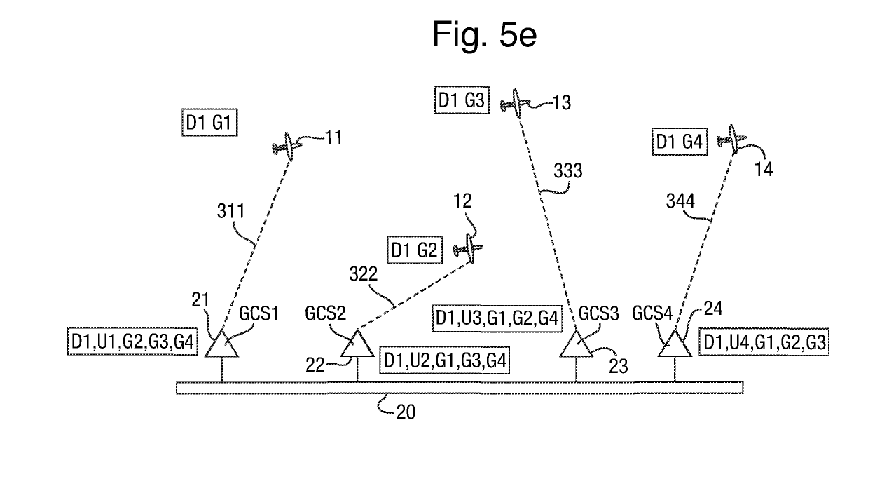

FIGS. 5a-e represent the stages which occur during a shared situational awareness updating process; and

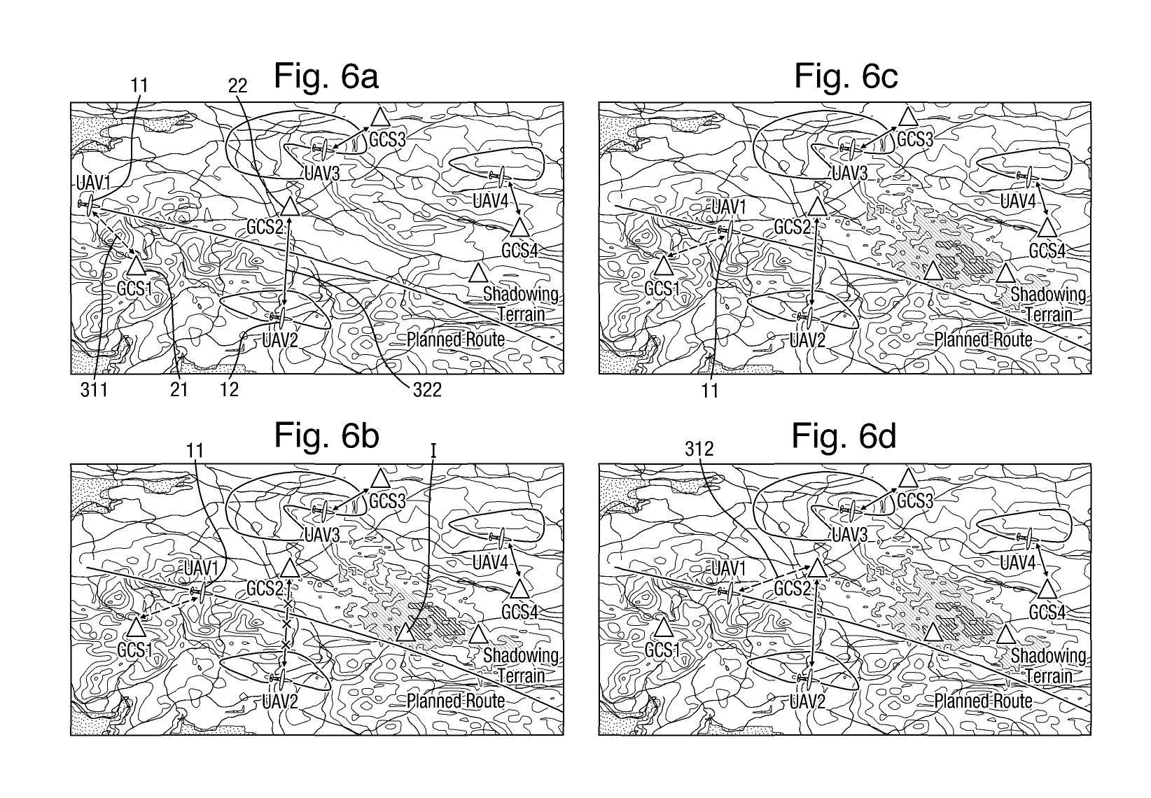

FIGS. 6a-d represent a scenario wherein an MCP within an adaptive communications network responds to the detection of a region of interference within the RF environment.

In the embodiments described, the invention has been implemented in the context of a communications network amongst unmanned aerial vehicles (UAVs) and their Ground Control Stations (GCSs). Each UAV may be considered as an instance of an MCP and each GCS may be considered as an instance of a Base Station. The term ‘platform’ has been used to cover any entity capable of forming a communications link i.e. an MCP, a Base Station or an ATC.

As shown in FIG. 1, an infrastructure for an adaptive communications network 1 comprises a plurality of Mobile Communications Platforms 11-13 (MCPs), base stations 21-23 (GCSs) and air traffic controllers (ATCs) 31-32.

In the instance represented in FIG. 1, a first MCP-to-base communications link 311 is established between a first MCP 11 and a first GCS 21. Further, a second MCP-to-base communication link 322 is established between a second MCP 12 and a second GCS 22. Still further, a third MCP-to-base communications link 333 exists between a third MCP 13 and a third GCS 23.

The three GCSs 21-23 are able to communicate via the bus 20 which has the form of a hardwired electrical connection.

The three MCPs 11-13, which in the present embodiment are Unmanned Aerial Vehicles (UAVs), have established a dedicated MCP-to-MCP Wide Area Network (WAN), operating on its own dedicated frequency band. As such, an MCP-to-MCP communications link 212 is established between MCP 11 and MCP 12; an MCP-to-MCP communications link 223 is established between MCP 12 and MCP 13; and an MCP-to-MCP communications link 213 is established between MCP 11 and MCP 13.

Alternatively or additionally, the MCPs can establish links amongst one another through a satellite link (e.g. SATCOM). However, other network/communications protocols may be contemplated.

If a direct MCP-to-MCP link, e.g. link 213 between MCPs 12 and 13, is compromised then an intermediate MCP 12 may be used as to relay information between MCP 11 and MCP 13 via links 212 and 223. Further, if a particular MCP is unable to establish an MCP-to-base link, that particular MCP may route its traffic to a GCS though another MCP until an MCP-to-base link can be re-established for that particular MCP.

The network 1 also includes a first and second ATC 31 and 32 respectively. In the instance shown in FIG. 1, the first ATC 31 has established MCP-to-ATC communications links 411 and 412 between MCP 11 and MCP 12 respectively. The second ATC 32 has established an MCP-to-ATC communications link 423 with MCP 13.

The MCP-to-ATC links are in the VHF region of the spectrum and each MCP is provided with a radio module for effecting communications with the ATCs 31 and 32.

Each MCP 11-13 is provided with a Means of Manoeuvring 102 (alternatively referred to as a Navigation Module 102), a Processing Module 104 and a Communications Module 106. As an example, FIG. 2 shows these features as present in the first MCP 11.

In the context of UAVs the Means of Manoeuvring 102 would include the flight control and planning systems, control surfaces and navigational systems.

The means 102 outputs NAV data 41, which is received as an input to the processing module 104. In relation to UAV communications planning, the NAV data 41 includes current time and current position (latitude, longitude and altitude).

The processing module 104, which would be for example implemented on a microprocessor or FPGA, receives the NAV data 41 as an input and consequently may output the radio settings 44, the communications plans 43, the shared situational awareness controller update message 50, and the shared situational awareness controller status message 48 to the communications module 106.

Communications module 106 interfaces the MCP 11 with the external RF environment 108 and thus serves to establish and maintain communications links, which in this instance are MCP-to-base link 311, MCP1-to-MCP2 link 212 and MCP1-to-MCP3 link 213. Communication module 106 would generally comprise a radio transceiver interconnected with an antenna (not shown).

The processing module 104 comprises five sub-modules: a Communications Forward Planning Agent 110, a Communications Plan Implementer 120, a Reactive Communications Agent 130, a Shared Situational Awareness Controller 140, and a Mission Planner 150.

The Communications Forward Planning Agent 110 has NAV data 41 and Shared Situational Awareness data 42 as inputs, and has Communication Plans 43 as an output.

The Communications Forward Planning Agent 110 is able to call on the Random Neural Network algorithm (RNN) module 60 and does so in order to optimise the selection of links and frequencies for a future communications plan.

For each MCP, a communications plan within the communications plans 43 specifies the links (e.g. MCP-to-base link 311) to be used for communications during the mission. It is assumed that all links are bi-directional and point to point. An MCP should be provided with a link to a GCS. A GCS should be provided with a link to each of the UAVs it controls and links to all other GCSs. GCS to MCP communication will use dynamically allocated channels; whilst inter GCS communication uses a pre-allocated channel 20. The communication plans 43 contain information about all links used by an MCP both preallocated and dynamically assigned. The forward planning agent 110 generates an initial communications plan based on an initial mission plan for all MCPs as well as the above communication requirements.

If the mission plan 47 or the radio environment 108 changes it may be necessary to modify the communications plans 43. The Communications Forward Planning Agent 110 is responsible for determining complete new communication plans 43 appropriate to the altered. Forward planning will only update managed links, i.e. MCP to GCS links. Note a MCP is not controlled by a fixed GCS, instead the GCS as well as the physical link is requested based on link quality. One GCS may control multiple MCPs.

An MCP's mission 47 and local environment 46 are part of its situational awareness data. By sharing this data all MCPs can develop an awareness of the global state of the world. This data, known as shared situational awareness data 42, contains an identifier 49 (denoted ssa_id in FIG. 3) which is incremented when the mission is revised. By comparing the current value of this identifier with its previous value, the agent is able to determine whether forward planning is required.

An MCP should be able to communicate with all other MCPs and so the situational awareness 42 on all MCPs should be the same. Because of this the communications plans 43 produced by the different MCPs 11-13 should be identical.

The communication plans 43 comprise of a set of plans; one per platform. The format of the set of plans data is as a group containing a time, identifier, number of plans, and a communication plan for each MCP. The data describing the communication plan for each MCP includes a mission time at which to apply a particular plan to that MCP, an expected position of that MCP at that mission time, the identity of the linked-to entity (e.g. a MCP, Base station or ATC), the frequency to use for the link, and the expected signal quality.

The Communications Plan Implementer 120 has NAV data 41, Communications Plans 43, and Communications Plan Update 45 as inputs. Consequently, the Communications Plan Implementer 120 provides Radio Settings 44 as output.

The Communications Plan Implementer 120 is responsible for determining the frequencies to use for communications at a current time.

The Communications Plan Implementer 120 reads time and location information from the NAV data 41. It uses the updated communications plan 45 if available; otherwise it uses the original communications plan 43. Implementer 120 selects the frequencies to use from the communications plan based on the current time. It then uses this information to construct the radio settings data 44. In order to detect requests to relay data, a UAV platform must listen on all GCS-UAV links not just its own.

Radio settings 44 describe the physical links currently used by the platforms to communicate with other platforms. The maximum number of links is fixed. The actual number of links is specified in the message.

Each physical link is identified by its name. The mapping of name to frequency and service is specified in the radio settings message. Transmitter and receiver(s) will use the same name for a particular link. Also specified in the radio settings message is the name of the remote platform that the current platform wants to receive messages from.

The Reactive Communications Agent 130 has NAV data 41, Communications Plans 43, and Shared Situational Awareness Data 42 as inputs. Consequently, the Reactive Communications Agent 130 provides the Communications plan update 45 and Radio Quality 46 as outputs.

The Reactive Communications Agent 130 is able to call on the Random Neural Network algorithm (RNN) module 60 and does so in order to optimise the selection of links and frequencies for the current communications plan.

If the channel quality (e.g. MCP-to-base link 311) deteriorates it may be necessary to modify the communications plan 43. The Reactive Communications Agent 130 will determine a new channel to be used in the short term whilst in the long term reverting to the original communications plan 43.

The Reactive Communications Agent 130 will generate a communications plan 43 for the current time step. It notifies the Communications Plan Implementer 120 of changes to the communications plan 43 by setting the identifier field of the communications plan update message to a non-zero value.

Subsequent changes to the communication plan 43 will override any communications plan updates.

Not all links are managed i.e. not all links can be re-allocated to different physical links. Those links that can be managed can be identified from the communications plans 43.

The Reactive Communications Agent 130 receives information on the actual received signal quality of each of its links from the radio interface. However it only reacts to changes in the link quality of managed links. By comparing the actual signal quality 46 with the expected quality in the communications plan 43 it is able to determine whether a significant deterioration in the radio environment 108 has occurred. To avoid over-reacting to short-term effects the Reactive Communications Agent 130 checks radio quality 46 for a number of consecutive cycles before initiating re-planning.

When the Reactive Communications Agent 130 determines that one of its links is no longer providing adequate signal quality it updates its situational awareness data 42. In the case of a UAV that can no longer communicate with its GCS (e.g. the MCP-to-base link 311), traffic will be routed though another UAV until direct communications can be re-established.

As situational awareness data 42 is exchanged with all platforms the other platforms will become aware of the change in link quality.

Once all platforms have reached agreement as to the new state of the system, communications planning is invoked. Because the shared situational awareness 42 is the same on all platforms the results of communications planning should be the same on all platforms.

A flow chart for the Reactive Communications Agent 130 is provided at FIG. 3.

The Shared Situational Awareness Controller 140 has Shared Situational Awareness Controller Status Message In 48a (SSAC S In), Shared Situational Awareness Controller Update Message In 50a (SSAC U In), Mission Plan 47, and Radio Quality 46 as inputs.

Consequently, the Shared Situational Awareness Controller 140 provides

Shared Situational Awareness Controller Status Message Out 48b (SSAC S Out), Shared Situational Awareness Controller Update Message Out 50b (SSAC U Out), and Shared Situational Awareness Data 42 as outputs.

The Shared Situational Awareness Controller 140 is responsible for sharing situational awareness data between platforms. Having shared situational awareness allows agents on the different platforms to make coherent decisions about frequency assignment.

Shared situational awareness 42 comprises of a set of data. Each item of data describes a change in the environment as detected by a particular platform, e.g. a change in a platform's mission, or detection of an interference source.

Platforms forward changes in shared situational awareness in Shared Situational Awareness Controller messages (e.g. 48a, 48b, 50a, 50b). A platform will forward data it has received from other platforms as well as data it has generated itself.

Each item of situational awareness data contains an identifier 49 (ssa_id 49) supplied by the platform generating the data. Each platform lists the most recently received identifiers of the data in the shared situational awareness status message 48a, 48b. This message is sent to neighbours who forward any more recent data they possess in Shared Situational Awareness Controller update messages 50a, 50b. This allows the algorithm to operate correctly in the presence of packet loss.

Shared Situational Awareness Controller status messages 48a, 48b are used to determine when the shared situational awareness 42 has converged i.e. is the same on all platforms. This is a necessary pre-condition for running communications planning if the calculations on the individual platforms are to produce the same results.

To enable timely convergence, once a platform has observed a change in the situational awareness data, either its own or another platform's, it will avoid making any further changes to the shared situational awareness 42 until convergence has been achieved. Subsequent changes in its local situational awareness will be logged to be acted on later.

If all communications with a platform are lost, e.g. if the platform fails, the remaining platforms will exclude the lost platform in order to achieve convergence amongst themselves.

Normally a UAV only exchanges situational awareness with its own GCS. However, in the case that a UAV loses its link to the GCS it will ask a neighbour UAV to relay data between itself and the GCSs.

The mission plan loader 150 provides a mission plan 47. These may be preloaded into processing module 104 and accessed appropriately or may be updated according to instructions from the Means of Manoeuvring module 102.

As discussed, the Communications Forward Planning Agent 110 and the Reactive Communications Agent 130 are able to call upon the RNN module 60 to determine, for each platform making a request for a re-allocated link, which channel and linked-to platform to allocate.

In the RNN algorithm, R is the set of requests r, with priority K(r) and C is the set of channels c; A(r, c) is the allocation function, set to 1 if request r is allocated channel c, 0 otherwise; S(r, c) is the received signal power at each terminal of request r on channel c; N(r, c) is the total receiver noise, external noise and jammer power experienced by request r on channel c, and I(r, r′, c) is the interference power which would be received by request r using channel c as a result of request r′ also operating on that channel; all powers are expressed in dBm. These powers are functions of r as well as c because they may depend on the geographical location of the terminals represented by r; the priority K(r) is in dB and represents the relative importance in the request in terms of its signal/interference ratio.

Thus the signal/interference ratio of request r on channel c is:

$$S ( r , c ) - [ N ( r , c ) ⊕ {\sum }_{rcR , {r}^{′} \neq r}^{⊕} A ( {r}^{′} , c ) I ( r , {r}^{′} , c ) ] \qquad Equation 1$$

Where the operator ⊕ denotes linear summation of powers, which is an appropriate way to combine independent sources of noise. If the two terminals of the request have unequal powers or noise levels, the worst case is taken. The negative of the (logarithmic) signal/interference ratio is a measure of the allocation cost for that request. The cost function to be minimised is therefore:

$${Q}^{*} = {\sum }_{rcR} {\sum }_{c = C} A ( r , c ) \{ [ N ( r , c ) ⊕ {\sum }_{{r}^{′} cR , {r}^{′} \neq r}^{⊕} A ( {r}^{′} , c ) I ( r , {r}^{′} , c ) ] - S ( r , c ) - K ( r ) \} \qquad Equation 2$$

Let the maximum acceptable cost per request (negative of the priority-weighted minimum signal/interference ratio) be Q. Then a solution satisfies:

$$Q \vert R \vert \vert C \vert = {\sum }_{rcR} {\sum }_{c = C} A ( r , c ) \{ [ N ( r , c ) ⊕ {\sum }_{{r}^{′} cR , {r}^{′} \neq r}^{⊕} A ( {r}^{′} , c ) I ( r , {r}^{′} , c ) ] - S ( r , c ) - K ( r ) \} \qquad Equation 3$$

Where |R| and |C| are the number of elements in R and C respectively. Then a particular solution with equal cost per channel is given by:

$$A ( r , c ) = \frac{Q + K ( r ) / \vert C \vert}{[ N ( r , c ) ⊕ {\sum }_{rcR , {r}^{′} \neq r}^{⊕} A ( {r}^{′} , c ) I ( r , {r}^{′} , c ) ] - S ( r , c )} \qquad Equation 4$$

As such, Equation 4 tends to assign a score for combinations of request (i.e. communication link) and channel. A system-wide solution should seek to have a sum of A(r,c) values which is maximised.

A process whereby Equation 4 may be implemented in a software environment such that it may be solved iteratively shall now be described with reference to FIGS. 4a-h

The design of the iterative RNN algorithm may be implemented in C# programming code, in which case the code comprises of a set of C# classes modelling entities in the system as shown in Table 1.

TABLE 1

| | |
|---|---|
| Program | Main program. |
| HTTPServer | Class to listen for and process HTTP request messages. |
| Terminal | Class representing a platform. One instance is required |
| | for each platform in the system |
| Request | Class representing a request for a channel. This contains |
| | a pair of Terminals which need a communications link. |
| Interferer | Class representing a source of interference or jamming. |
| Location | Class representing a geographical location |
| Channel | Class representing an allocatable channel. |
| RNNAlgorithm | Class which performs the allocation algorithm. It |
| | contains collections of instances of Request and Channel |

As shown in FIG. 4a, the main program initialises an instance of TCPServer which listens on a dedicated port for allocation requests.

The next class is shown at FIG. 4b, a class representing an HTTP server. When the listener receives a request, it runs Process( ) in a new thread. This function creates an instance of RNNAlgorithm which parses the received request and creates a new document containing the response, which is returned to the client.

The classes shown in FIG. 4c represent the name and geographical position of a terminal or an interference source. Terminal has properties representing its transmit power, receiver internal noise power and required signal/interference ratio. Interferer has properties representing the frequency it affects and the degree of S/I ratio degradation it causes (in dB relative to receiver noise power.)

Terminal and Interferer both have a function Signal( ) which returns the received power in dBm which this object would produce on a given Terminal and Channel.

Terminal.Signal( ) uses an instance of CovmodServer to calculate the received power due to this terminal at some other terminal, based on the propagation path loss between the terminals and its Power property.

Interferer.Signal( ) is intended to return the received power due to this interferer at the given Terminal. In fact this implementation is a simplified one which returns a large negative value unless the channel's frequency matches its Frequency property and the terminal is within some fixed distance of its Location. If this is the case it returns the sum of the terminal's Noise and its own Degradation properties. Later versions of the software might offer a more realistic implementation.

Channel class represents a single channel, denoted by a name and its associated frequency in MHz. Its constructor parses a fragment of XML to read its properties.

The ConvmodHandler class is for interacting with the COVMOD radio propagation prediction service. It has a single function GetPathLoss( ) which takes two Terminals and the frequency in MHz as parameters, and returns the path loss between them in dB as the result.

The request class, illustrated in FIG. 4f, represents a request for a communications link between two terminals. Its constructor parses a fragment of XML to extract its properties. Properties UAV, GCS, Priority describe the terminals and the request priority. For use by the allocation algorithm, this class also records the currently allocated channel and has two internal arrays containing the current and new values of the allocation score A(r, c) computed for this request r and each available channel c, representing the channel by an integer index. Function Clearscores( ) initialises these arrays for the number of channels specified in its first parameter. Values can be read from the current array via function Score(channel) and pending values can be inserted into the new array via NewScore(channel, value). Function UpdateScores( ) copies the pending values into the current array, and returns true if any score has changed significantly. Function Assign( ) assigns the given channel to the request and sets its current scores to 1 for the given channel, 0 for all others. Read-only property Channel is the index of the allocated channel.

The response classes represent the result of an allocation. ResponseMessage contains an array of Allocations, each of which contains the names of a Request and the allocated Channel. The read-only property XML represents the allocation as an XML document.

Shown in FIG. 4h, the interface AssignmentAlgorithm class represents an allocation algorithm. Classes which implement this interface will typically also be derived from the utility class AssignmentBase, which simply contains lists of request data and functions to access them. Function Read( ) parses an XML document and populates the lists Requests, Channels and Interferers with sets of requests, channels and interferers. Function Assign( ) performs an allocation and returns an XML document representing the allocation. When this function returns, the Channel property of each element of Requests will be set to the integer index into Channels of the allocated channel.

Class ExhaustiveAlgorithm is a simple implementation of IAssignmentAlgorithm which exhaustively searches all combinations of requests and channels to find the one with the lowest cost. This implementation may be used to generate a brute-force benchmark solution.

Class RNNAlgorithm is an implementation of IAssignmentAlgorithm which uses Equation 4 as follows:

For all elements of Requests, clear any existing allocation.

Perform the following as many times as there are elements in Requests (each iteration will perform exactly one allocation, and requests are not changed once allocated):

1. Call r.ClearScores (Channels.Count) for all unallocated elements r of Requests.
2. Compute the maximum Qmax over all elements r of Requests and elements c of Channels, of the acceptable priority-weighted cost Q=−(r.terminal.SlRequired+r.Priority/Channels.Count) where terminal is UAV or GCS.
3. Until there is no significant change in the scores, do the following:

a. for each unallocated element r of Requests, and each element c of Channels,
i. calculate the new score A=(r Priority/Channels.Count+Qmax)/(I−r.GCS.Signal (r.UAV, c)) where I is the power sum of the following:
   for each terminal u of all elements o of Requests other than r, the product u. Signal (r.UAV, c)*o.Score(c)
   for all elements q of Interferers, q.Signal(r.UAV, c)
   r.UAV.Noise(c).
ii. Repeat step (i), exchanging r.UAV and r.GCS.
iii. Assign the smaller of the two values of A as r′s new score for channel c, by calling r.NewScore(c, A)

b. For each unallocated element r of Requests call r.UpdateScores( ) and note whether any scores have changed. (Note that this step changes all requests' “old” scores to their “new” values, so it cannot be merged with the previous step, which uses the “old” values.)

4. Searching over each unallocated element r of Requests, and each element c of Channels, find the largest element of r.Score(c) and note the request and channel r*, c*.

### 5. Call r*.Assign(c*)

Whilst the RNN optimisation algorithm has been used in the described embodiment, the skilled man would understand that other metaheuristic algorithms may be used as alternatives. For example, a Max sum algorithm may be used.

FIGS. 5a-e illustrate how, in operation, situational awareness data would be shared. For simplicity, Shared Situational Awareness Controller status messages 48a, 48b are not displayed. In FIG. 4a UAV1/MCP 11 detects a change D1 in its environment and sends a Shared Situational Awareness Controller update message 48b to its ground control station, GCS1 21. In FIG. 4b, GCS1 21 forwards the data to the other ground control stations.

In FIG. 5c the GCSs forward the data to their UAVs. The data D1 is successfully received at UAV2 and UAV4 but not at UAV3.

In FIG. 5d, the shared situational awareness data at GCS3 has been updated to reflect that D1 has been received by GCS1 21, GCS2 22, and GCS3 23 but not UAV3/MCP 13. GCS3 23 re-transmits D1 to UAV3/MCP 13.

In FIG. 5e, UAV3/MCP 13 has received D1 and the shared situational awareness data at GCS3 23 has been updated to reflect this.

The operation of the described embodiment has been simulated in a software environment. During such simulation, and as shown in FIGS. 6a-g, the network 1 is able to respond to the scenario where a source of interference is detected.

The initial situation is shown in FIG. 6a where four UAVs (UAV1, UAV2 and UAV3 and UAV4) have mission plans (i.e. the route plans shown in a solid black line) for navigating an environment. Each UAV is initially allocated a GCS (numbered 1-4 respectively) and has established a communications link therewith.

UAV2-4 are patrolling in a closed loop and do not stray from the range of their initially-allocated GCS.

UAV1 is to navigate across the map from left to right. However upon UAV1 reaching the position shown in FIG. 6a, an interferer, I, appears on the map and the quality of the radio signal received at UAV2 from GCS2 deteriorates. However, UAV2 detects this degradation in signal quality and accordingly its processing module 104 calls upon the RNN module 60 to determine an updated communications plan 43 and also issues a SSAC status message to the network.

As a result of this, the processing module 104 causes Communications Module 106 to establish a communications link 322 with GCS2 at a new frequency which proves to be unaffected by the Interferer. See FIG. 6c.

As UAV1 continues to proceed away from the range of GCS1 and towards the range of GCS2, UAV1 is issued with a SSAC status message, and subsequently a SSAC update message which leads to a communications plan update such that as UAV1 hands over from GCS1 to GCS2 (as shown in FIG. 6d), UAV1 does not establish a communications link 312 with GCS2 at the Interferer-susceptible channel frequency.

It can be understood that similar updates to communication plans may be initiated in other scenarios. For example UAV1, upon entering an area where terrain shadows a certain signal may be prompted to recalculate its communications plan. In such circumstances, the UAV1 may calculate, based on shared situational awareness data that by proceeding upon its course will soon take it from the shadowed terrain, and hence an optimised solution may be to simply re-establish the currently shadowed link as soon as possible.

By way of further example, in the scenario where UAV1 receives a new route plan which deviates from the previous route plan, the receipt of such a plan will cause UAV1 to issue a situational awareness update message to neighbouring platforms. The UAV1 and the platforms may then proceed to calculate an optimised set of communication plans for each other given the latest data update on UAV1s route plan.

The skilled reader will appreciate that whilst the above-described network infrastructure has static, ground-based Base Stations, and also moving MCPs, the invention could equally be implemented on a plurality of moving platforms only or a plurality of static platforms only.

1. A method of adapting a communications network, the method comprising:
providing at least a first and second base station operable to communicate with one another and with a plurality of mobile client platforms (MCPs);
providing at least a first and second MCP, each provided with a communications module, a processing module, and a navigation module,
the first MCP being provided with and operable to execute:
a first initial route plan; and
a first initial communications plan for maintaining a communication link with either of the base stations, and being operable to collect and transmit first situational awareness data,
and the second MCP being provided with and operable to execute:
a second initial route plan; and
a second initial communications plan for maintaining a communication link with at least one of the base stations, and being operable to collect and transmit second situational awareness data,
the method further comprising:
establishing a first initial communications plan, the plan identifying an MCP-to-base communications link between the first MCP and the first base station, the first communications link having a first channel frequency;
generating first situational awareness data at the first MCP;
receiving second situational awareness data at the first MCP; and
calculating for the first MCP a first updated communications plan.

2. A method according to claim 1 wherein the updated communication plan is calculated according to a metaheuristic algorithm.

3. A method according to claim 2 wherein the metaheuristic algorithm is a Random Neural Network (RNN) algorithm

4. A method according to claim 3 wherein the RNN algorithm, given a set of link-to communication requests from a plurality of platforms, and a set of channels, allocates to each MCP a platform with which to form a link and a channel on which to communicate, by seeking to maximise the following cost function across the network:
$$A ( r , c ) = \frac{Q + K ( r ) / \vert C \vert}{[ N ( r , c ) ⊕ {\sum }_{rcR , {r}^{′} \neq r}^{⊕} A ( {r}^{′} , c ) I ( r , {r}^{′} , c ) ] - S ( r , c )} ;$$
where R is the set of requests r, with priority K(r) and C is the set of channels c; A(r, c) is the allocation function, set to 1 if request r is allocated channel c, 0 otherwise; S(r, c) is the received signal power at each terminal of request r on channel c; N(r, c) is total receiver noise, external noise and jammer power experienced by request r on channel c, and I(r, r′, c) is interference power which would be received by request r using channel c as a result of request r′ also operating on that channel; all received signal powers are expressed in dBm and are functions of r as well as c because they may depend on the geographical location of the terminals represented by r; and the priority K(r) is in dB and represents the relative importance in the request in terms of its signal/interference ratio.

5. A method according to claim 1 further comprising:
establishing a second initial communications plan, the plan identifying an MCP-to-base communications link between a second MCP and a second base station at a second channel frequency;
generating second situational awareness data at the second MCP;
receiving first situational awareness data at the second MCP; and
calculating for the second MCP a first updated communications plan.

6. A method according to claim 1 wherein the first or second MCP generates situational awareness data comprising: a route plan, a communications requirements forecast, and a radio quality report.

7. A method according to claim 1 wherein the first updated communications plan defines an updated channel frequency for the MCP-to-base link.

8. A method according to claim 1 wherein each communications plan includes a channel allocation between the respective MCP and at least one of the base stations.

9. A method according to claim 1 wherein a particular MCP transmits its respective situational awareness data, as an update, upon detection by the particular MCP of a predefined stimulus.

10. A method according to claim 1 further comprising:
establishing a second initial communications plan, the plan identifying an MCP-to-base communications link between a second MCP and a second base station at a second channel frequency;
generating second situational awareness data at the second MCP;
receiving first situational awareness data at the second MCP; and
calculating for the second MCP a first updated communications plan;
wherein calculating a first updated communications plan for the first MCP and/or establishing a second initial communications plan are initiated after a predetermined time period has elapsed since the previous execution of that calculating and/or establishing.

11. An adaptive communications network, the network comprising:
at least a first and second base station operable to communicate with one another and with a plurality of mobile client platforms (MCPs);
at least a first and second MCP, each provided with a communications module, a processing module, and a navigation module;
the first MCP being provided with and operable to execute:
a first initial route plan; and
a first initial communications plan for maintaining a communication link with either of the base stations, and being operable to collect and transmit first situational awareness data,
and the second MCP being provided with and operable to execute:
a second initial route plan; and
a second initial communications plan for maintaining a communication link with at least one of the base stations, and being operable to collect and transmit second situational awareness data,
wherein the communications modules of the first and second MCP are configured to communicate situational awareness data with each other using their communications modules, to process the output from the communications module at the processing module to determine an updated route plan and updated communications plan, to implement the updated route plan at the navigation module, and to implement the updated communications plan at the communications module.

12. An adaptive communications network according to claim 11 wherein the communications module comprises an ATC communications module.

13. An adaptive communications network according to claim 11 wherein each communications module comprises a module for communicating directly with other MCPs.

14. An adaptive communications network according to claim 13 wherein each communications module comprises an IP network module such that each MCP is operable to form an IP network with other local MCPs and thereby share situational awareness data.

15. An adaptive communications network according to claim 11 wherein each MCP communications module comprises a Base Station communications module for establishing and maintaining a MCP-to-base link.

16. An adaptive communications network according to claim 15 wherein the Base Station communications module is operable over a 400-900 MHz UHF frequency range such that a MCP-to-base link may be provided within a 400-900 MHz UHF channel.

17. An adaptive communications network according to claim 11 wherein each MCP communications module comprises a Satellite Communication module.

18. An adaptive communications network according to claim 11 wherein at least the first and second base stations are electrically interconnected by a hardwired connection.
